(19) United States
(12) Patent Application Publication
(10) Pub. No.: US 2015/0055644 A1
(43) Pub. Date: Feb. 26, 2015

(54) PRECISE TIMESTAMPING OF ETHERNET PACKETS BY COMPENSATING FOR START-OF-FRAME DELIMITER DETECTION DELAY AND DELAY VARIATIONS

(71) Applicant: LSI Corporation, San Jose, CA (US)

(72) Inventors: Mark A. Bordogna, Andover, MA (US); Douglas M. Brinthaupt, Bethlehem, PA (US); Alexander Anesko, Brunswick, ME (US)

(73) Assignee: LSI Corporation, San Jose, CA (US)

(21) Appl. No.: 14/062,150

(22) Filed: Oct. 24, 2013

Related U.S. Application Data
(60) Provisional application No. 61/868,710, filed on Aug. 22, 2013.

(51) Int. Cl. H04W 56/00; H04L 12/26; H04W 24/08

(52) U.S. Cl. CPC H04W 56/004; H04W 24/08; H04L 43/106
USPC 370/350

(57) ABSTRACT

An apparatus includes a synchronization block and a physical coding sublayer block. The synchronization block may be configured to determine a position of a start of frame delimiter. The physical coding sublayer block may be configured to measure a delay through the physical coding sublayer block and provide delay and delay variation compensation based upon the measured delay.

This application relates to U.S. Provisional Application No. 61/868,710, filed Aug. 22, 2013, which is hereby incorporated by reference in its entirety.

### FIELD OF THE INVENTION

The invention relates to telecommunications generally and, more particularly, to a method and/or apparatus for implementing precise timestamping of Ethernet packets by compensating for start-of-frame delimiter detection delay and delay variations.

### BACKGROUND

In a wireless network, providing highly accurate timestamps is necessary for obtaining precise Time of Day (ToD) synchronization. The more precise the timestamps, the more accurate the ToD will be. Increasing the accuracy of the ToD leads to less interference between neighboring base stations and less perceptible delays during handoffs between base stations. Delay variations on the order of a few nanoseconds can impact the deployment and services offered. For example, the International Telecommunications Union (ITU) specifies time alignment errors as low as 65 ns (see, e.g., 3GPP 36.104 V8.5.0 2009-03, Section 6.5.3.1 Minimum Requirement) for multiple-input multiple-output (MIMO) deployments. As time alignment errors increase from node to node, certain MIMO deployments would not be possible.

It would be desirable to have a method and/or apparatus for implementing precise timestamping of Ethernet packets by compensating for start-of-frame delimiter detection delay and delay variations.

### SUMMARY

The invention concerns an apparatus including a synchronization block and a physical coding sublayer block. The synchronization block may be configured to determine a position of a start of frame delimiter. The physical coding sublayer block may be configured to measure a delay through the physical coding sublayer block and provide delay and delay variation compensation based upon the measured delay.

### BRIEF DESCRIPTION OF THE FIGURES

Embodiments of the invention will be apparent from the following detailed description and the appended claims and drawings in which:

FIG. 1 is a diagram illustrating a portion of an Ethernet transceiver in accordance with an embodiment of the invention;

FIG. 2 is a diagram illustrating a number of blocks of the Ethernet transceiver of FIG. 1;

FIG. 3 is a diagram illustrating a synchronization block in accordance with an embodiment of the invention controlling a PCS block of FIG. 2;

FIGS. 4(A-B) are a state diagram illustrating an example operation of the synchronization block of FIG. 3;

FIG. 5 is a diagram of an Ethernet frame containing a start-of-frame delimiter; and

FIG. 6 is a diagram illustrating an Ethernet reference model.

### DETAILED DESCRIPTION OF THE EMBODIMENTS

Embodiments of the invention include providing a precise timestamping of ethernet packets by compensating for start-of-frame delimiter detection delay and delay variations that may (i) determine and adjust fixed and variable delays associated with a physical coding sublayer (PCS) and with a serializer/deserializer (serdes), (ii) employ an in-band measurement scheme, (iii) detect delay variation change due to link synchronization dynamically, (iv) provide a measurement scheme that does not impact customer data, (v) provide a measurement scheme that does not consume Ethernet bandwidth, and/or (vi) be compatible with sync Ethernet, Legacy Ethernet, Ethernet standards and various optical Ethernet rates.

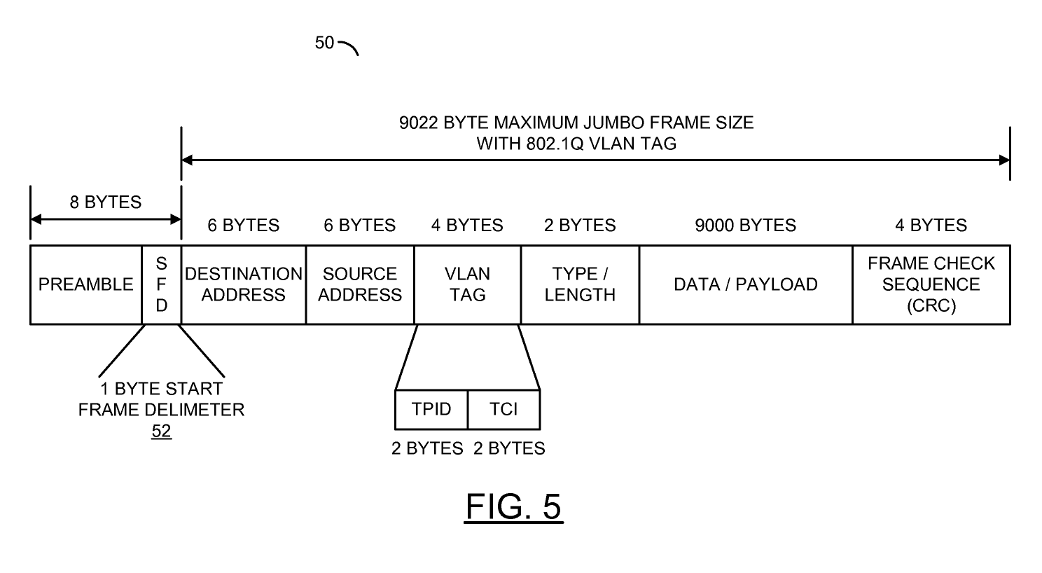

In wireless networks, precise timestamps of timing related packet arrivals and departures are important. Various embodiments of the invention provide a method of and/or apparatus for compensating delay and delay variations associated with the Ethernet Start-of-Frame delimiter detection, which is used to capture timestamps. In various embodiments, a compensation scheme determines and adjusts fixed and variable delays associated with a physical coding sublayer (PCS) and/or with a serializer-deserializer (serdes). In various embodiments, the compensation approach includes an in-band measurement scheme applied to the Ethernet PCS layer (see FIG. 6 below) for determining delay variations from a physical media attachment (PMA) to a media independent interface (MII). By removing the delay variation of the Ethernet PCS layer, the timestamping process becomes much more accurate. In some embodiments, other mechanisms are used to determine serdes delays as well. The combination of determining the serdes delays and the PCS delay/delay variations provides the necessary information to obtain precise timestamps.

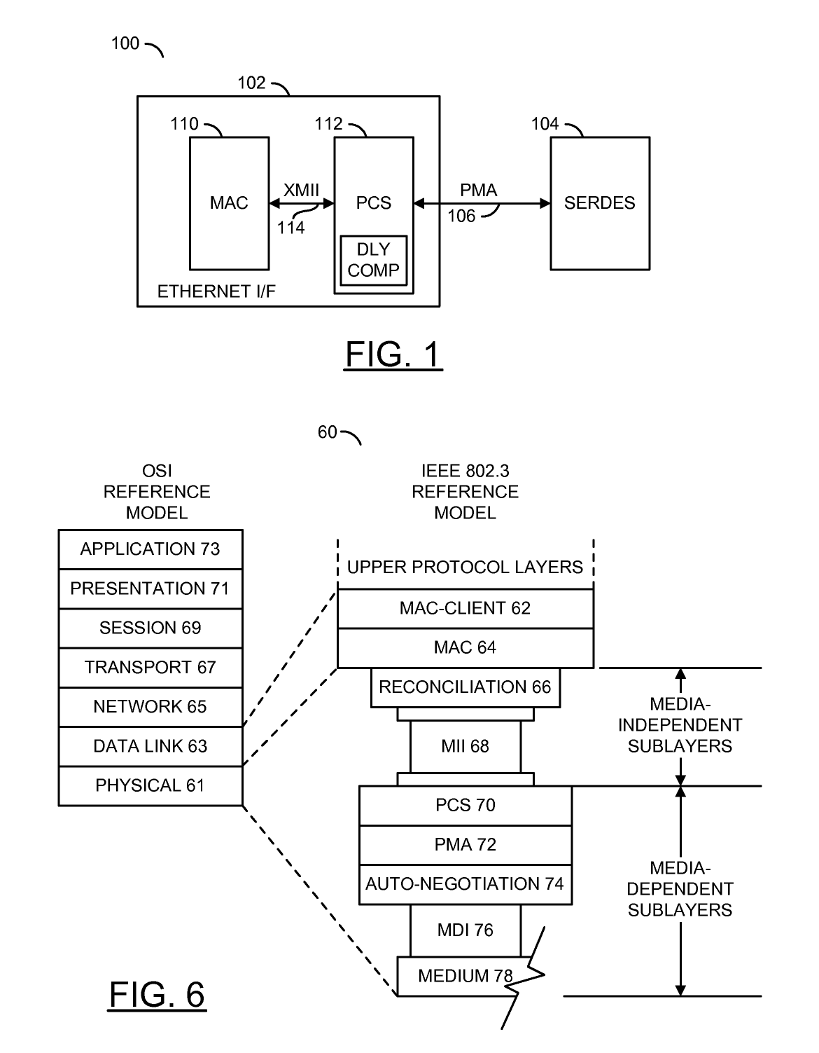

Referring to FIG. 1, a diagram illustrating a portion of an Ethernet transceiver 100 is shown. The Ethernet transceiver 100 may be configured to implement delay measurement and compensation schemes in accordance with embodiments of the invention. In some embodiments, the transceiver 100 comprises a block (or circuit) 102 and a block (or circuit) 104. The block 102 implements an Ethernet interface. The block 104 implements a serdes. The blocks 102 and 104 are communicatively coupled by an interface 106. In various embodiments, the interface 106 is implemented as an Ethernet physical medium attachment (PMA) sublayer (see FIG. 6 below).

In various embodiments, the block 102 comprises a block (or circuit) 110 and a block (or circuit) 112. The block 110 generally implements a media access control (MAC) sublayer. The block 112 generally implements a physical coding sublayer (PCS) module that includes delay/delay variation determination and compensation in accordance with an embodiment of the invention. The blocks 110 and 112 are communicatively coupled by an interface 114. In various embodiments, the interface 114 implements an appropriate variant of a media independent interface (xMII). The interface 114 is generally configured to implement an appropriate sublayer to meet a data rate of a particular implementation (e.g., GMII for 1 G, XGMII for 10 G, etc.).

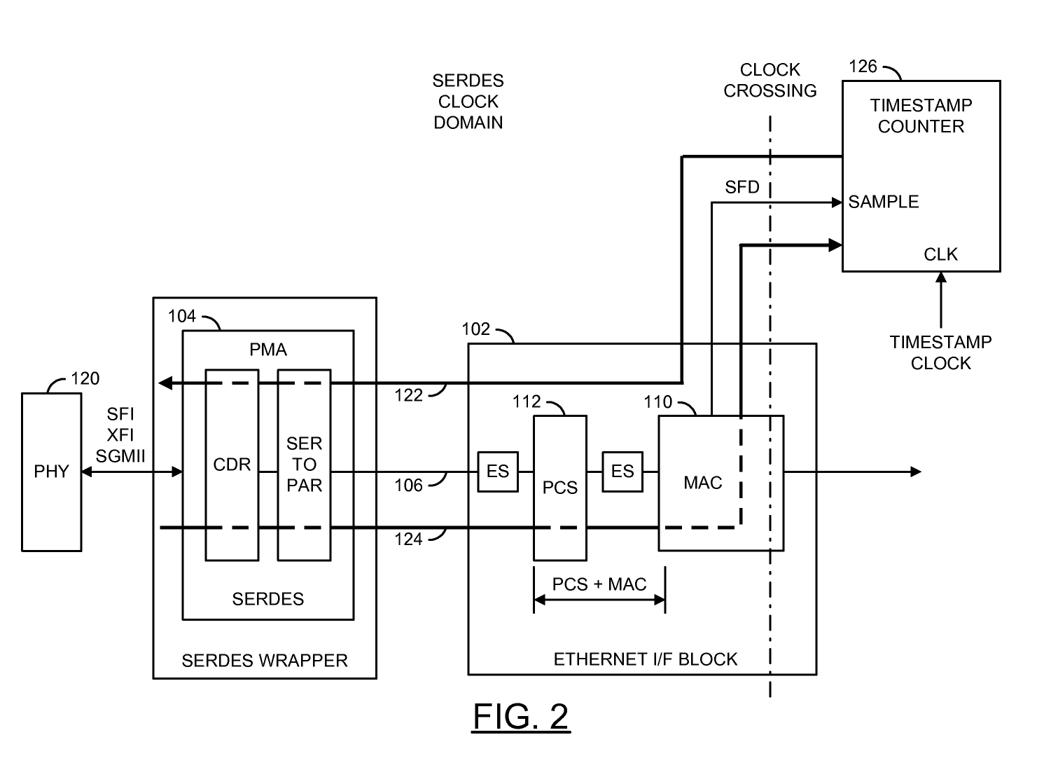

Referring to FIG. 2, a diagram is shown illustrating a number of blocks of an Ethernet transceiver in accordance with an embodiment of the invention. In an example of a PCS in-band measurement approach, a timestamp is taken at the interface 114 (MII) between the MAC 110 and PCS 112 layers. A MAC marker delay value allows translation of the timestamp to the PMA interface 106 between the PCS 112 layer and the serdes 104. The serdes delay is then factored into the calibration to determine the value at the device interface.

In various embodiments, the compensation scheme may be divided into a PCS delay measurement scheme for calibrating the delay variation through the PCS block 112 and a serdes delay determination scheme for determining the serdes delays. The PCS and serdes measurements are then combined to adjust the timestamp that is captured via the Start-of-Frame Delimiter (SFD). There is generally no clock boundary crossing through the PMA and PCS layers to the SFD detection point.

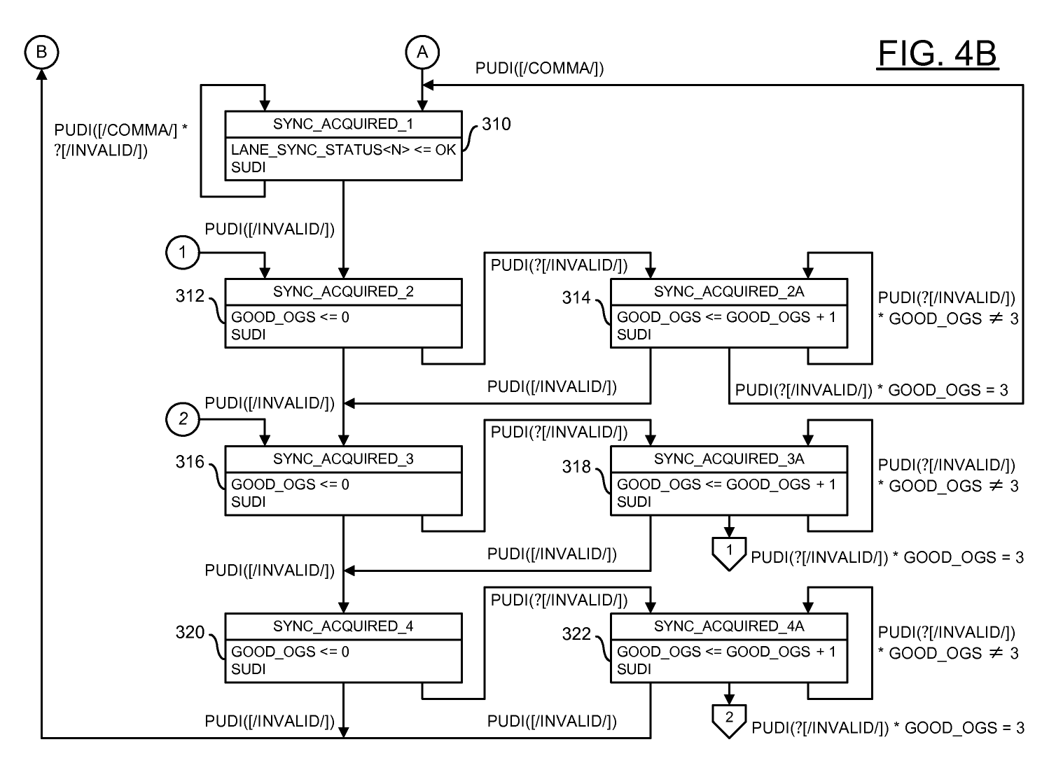

Timestamps for all link types and rates are recorded at the boundary between the Ethernet Start-of-Frame Delimiter (SFD) and the first octet of the Destination Address (DA) within the Ethernet Frame (see FIG. 5 below for reference). The point closest to the device pins where the SFD/DA boundary can be accurately determined is at the media independent interface (e.g., the interface 114) between the MAC module 110 and the PCS module 112. In various embodiments, timestamp marker delays measure the time between the SFD/DA boundary at the interface 114 and an equivalent point at the PMA interface 106 between the block 102 and the attached serdes block 104.

Each variant of the MII may have a different granularity for where the SFD/DA boundary occurs. For example, in GMII the SFD/DA boundary may occur on any octet boundary. In XGMII the SFD/DA boundary may occur on 4-octet boundaries only. In various embodiments, the measurement scheme follows the particular granularity through modules of the PCS and only looks at the equivalent boundary at the PMA interface 106. For example, for 8 B/10 B coded links, each octet at the XMII is equivalent to 10 bits at the PMA. For 64 B/66 B coded links, each 4-octets at the XMII is equivalent to 33 bits at the PMA. In various embodiments, the measurement scheme disregards the 66 B codeword structure (e.g., 2 sync header bits followed by 64 data bits) for timestamp marker delay purposes, and treats the 64 B/66 B coding process as a fixed delay regardless of whether the SFD/DA boundary occurs in the first or second half of the 64 bits.

Similarly, for Ethernet forward error correction (FEC) encoded links, a 2112 bit FEC frame is viewed as 64 equal instances of 33 bits. Treating the FEC frame as 64 equal instances allows the FEC module to be treated as a fixed delay. If instead the measurement is made to the actual compressed 66 B codewords within the FEC frame, the timestamp marker delay would vary from 0-32 bits per timestamp. Viewing the FEC frame as 64 equal instances of 33 bits is justified since the actual codeword boundaries cannot be directly determined at the device pins.

The total marker delay values include a fixed portion through the data path, and a variable portion due to codeword alignment at the PMA interface. In the transmit direction (illustrated by the line 122), the alignment of coded data at the PMA interface is controlled. The alignment delays are known and included in the marker delay values. In the receive direction (illustrated by the line 124), the alignment of coded data at the PMA interface is arbitrary. In each case, one or more elastic stores or buffers (ES) may be implemented in the path to compensate for the arbitrary alignment. The elastic buffers may be implements using first-in-first-out (FIFO) memories. The marker delay values essentially include the number of bits in the elastic buffer which is currently being used to align the coded data. The number of bits being used is fixed while a link is up. However, the number of bits may change whenever the link goes down or the serdes 104 is reset, because a new arbitrary PMA alignment may occur.

Timestamps are captured whenever the SFD is detected on predefined timing packets. The Ethernet packet typically arrives at a physical layer device (PHY) 120, is sent to the serializer/deserializer (serdes) interface 104, and then is sent to the physical coding sublayer/medium access control (PCS/MAC) block 102. Detection of the SFD occurs in the PCS/MAC block 102. The detection of the SFD triggers the timestamp capture (e.g., using a timestamp counter 126).

The serdes 104 is part of the physical medium attachment (PMA). The PMA performs functions including, but not limited to, (i) bit level multiplexing from M lanes to N lanes in the transmit direction, (ii) bit level demultiplexing from one lane (or N lanes) to M lanes in the receive direction, followed by shifting from the arbitrary boundary to the bus boundary or octet boundary, (iii) clock and data recovery, clock generation and data drivers, and/or (iv) loopbacks and test pattern generation and detection. In the receive direction, the physical coding sublayer (PCS) 112 follows the serdes block 104. In some embodiments, the PMA block has octet alignment to lock on to byte boundaries. In other embodiments, the PCS may incorporate a byte alignment block, or barrel shifter, that may be used to modify the data alignment within each multiple bit data word to lock onto byte boundaries. The PCS 112 performs functions including, but not limited to, scrambling/descrambling and delineating Ethernet frames.

In the receive direction, the serdes creates a parallel stream of data using an arbitrary starting point. If the parallel data stream is 10 bits (e.g., in the case of SGMII), then the SFD could reside at any point within the 10 bits. The parallel data stream is sent to the PCS block 112, which determines the octet synchronization and decoding of the SFD (e.g., using comma characters) for framing purposes. The octet synchronization determines the location of the SFD within the parallel data presented on a parallel bus connecting the serdes 104 to the PCS 112. If the SFD is not positioned at a boundary of the parallel bus or at the octet boundary, a delay is incurred in shifting the SFD to the parallel bus boundary. The delay incurred in shifting the SFD varies depending upon where in the parallel data the SFD is located. The shifting of the SFD to the parallel bus boundary causes a variable delay in the generation of the SFD.

The delay through the PCS block 112 varies each time the SFD position changes. The SFD position can change when a link synchronization event occurs. For example, if a loss of signal (LoS) occurs (e.g., a cable is unplugged), when the signal returns (e.g., the cable is plugged back in), the SFD position in the parallel data stream likely will have changed, resulting in a different delay through the PCS block 112. The delay variation can be up to one code word delay (e.g., 0-7.2 ns) in an 8 B/10 B PCS block, which applies to optical 1 gigabit Ethernet (GbE) links. In 10 GbE, using 66 b/64 b decoding, the delay can be up to a 66-bit code word (˜6.3 ns). Embodiments of the invention may be applied to other Ethernet rates including, for example, 1 G and 10 G where 8 B/10 B and 64 b/66 b coding/decoding is used. In various embodiments, the compensation scheme generally measures the delay variation that is occurring in the PCS block 112. Because the delay variation changes with every Ethernet re-synchronization, the compensation scheme allows for a re-calibration.

A clock crossing is shown in FIG. 2 between the SFD detection and the timestamp counter 126. However, the PCS block 112 and MAC block 110 may be asynchronous to each other, forcing a clock crossing between the blocks. A clock crossing between the PCS block 112 and the MAC block 110 may add inaccuracy.

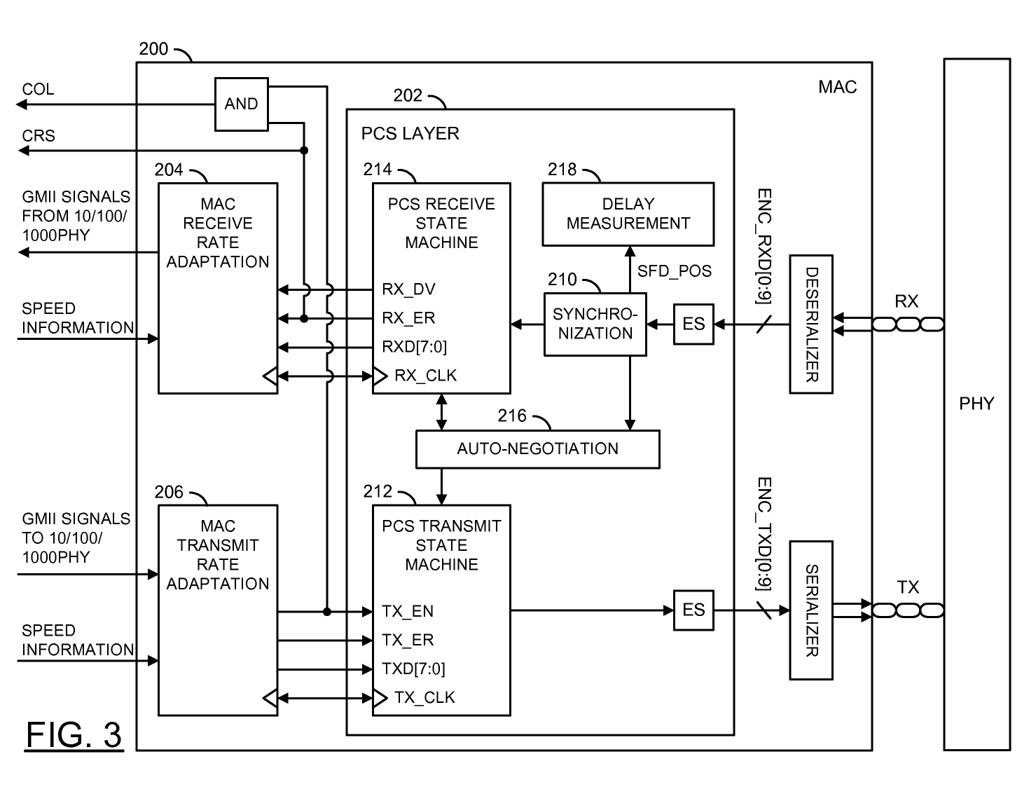

Referring to FIG. 3, a diagram is shown illustrating a media access control (MAC) sublayer 200 in accordance with an embodiment of the invention. The MAC sublayer block 200 generally includes a PCS layer 202, which may be implemented by the PCS block 112 of FIG. 2, a MAC receive rate adaptation block 204, and a MAC transmit adaptation block 206. The PCS layer 202 comprises a synchronization block 210, a transmit state machine 212, a receive state machine 214, an auto-negotiation block 216, and a delay measurement block 218. In various embodiments, the MAC 200 may determine and compensate for delay and delay variations in the PCS layer 202. In some embodiments, a processor (e.g., an embedded ARM processor) can compensate the timestamps based on the measured delay/delay variation values from the PCS or MAC block. The synchronization block 210 generally provides an SFD detection and alignment scheme, which allows the subsequent blocks to determine frame boundaries and fields within frames.

The PCS layer 202 can be broken down into four major functions: a synchronization process (performed by the block 210), a transmit process (performed by the block 212), a receive process (performed by the block 214), and an auto-negotiation process (performed by the block 216). Services provided to the GMII include: encoding/decoding of GMII data octets to/from ten-bit code groups (8 B/10 B) for communication within the underlying PMA; Carrier Sense (CRS) and Collision Detect (COL) indications; and managing the auto-negotiation process by informing the auto-negotiation process when the PCS has lost synchronization of the received code_groups. Auto-negotiation can be instructed to restart if configuration ordered_set groups (e.g., /C/) are received from the other station after the link has been established.

The purpose of the PCS synchronization process 210 is to verify that the PMA is providing octet alignment by correctly aligning code groups from the serial stream being received. PCS synchronization is acquired upon the reception of three ordered sets each starting with a code_group containing a comma symbol (e.g., /COMMA/ is the set of special code-groups that include a comma as specified in section 36.2.4.11 and are listed in Table 36-2 of IEEE Std 802.3-2008, each of which are incorporated by reference). Each comma must be followed by an odd number of valid data code_groups. No invalid code_groups can be received during the reception of these three ordered_sets (e.g., /INVALID/is the set of data or special code-groups as specified in section 36.2.4.6 of IEEE Std 802.3-2008, which is incorporated by reference).

Once synchronization is acquired, the synchronization process begins counting the number of invalid code_groups received. The count of invalid code-groups received is incremented for every code_group received that is invalid or contains a comma in an odd code_group position. The count of invalid code_groups received is decremented for every four consecutive valid code_groups received (e.g., a comma received in an even code_group position is considered valid). The count of invalid code_groups received does not fall below zero. If the count of invalid code_groups received reaches four, a signal of flag (e.g., lane_sync_status) is set to FAIL. Thus, once the signal lane_sync_status is set to OK, the synchronization process begins counting the number of invalid code_groups received. The count of invalid code-groups received is incremented for every code_group received that is invalid or contains a comma when an even numbered code_group is being received. The PCS synchronization process designates received code_groups as either even- or odd-numbered code_groups (e.g., as specified in section 36.2.4.1 of IEEE Std 802.3-2008, which is incorporated by reference) by setting a signal or flag (e.g., rx_even) to either TRUE or FALSE, respectively. The count of invalid code-groups received is decremented for every four consecutive valid code_groups received (e.g., a comma received when the signal or flag rx_even is FALSE is considered valid). The count of invalid code-groups received never goes below zero and if the count of invalid code-groups received reaches four, the signal lane_sync_status is set to FAIL.

The PMA performs the 10-bit serialize/deserialize functions (e.g., using the serdes 104). The PMA receives 10-bit encoded data at 125 MHZ from the PCS and delivers serialized data to the PMD sublayer. In the reverse direction, the PMA receives serialized data from the PMD and delivers deserialized 10-bit data to the PCS. The PCS and the PMA are both contained within the physical layer of the OSI reference model (see FIG. 6). The PCS and the Gigabit Media Independent Interface (GMII) communicate with one another via 8-bit parallel data lines and several control lines. The PCS is responsible for encoding each octet passed down from the GMII into ten bit code groups. The PCS is also responsible for decoding ten bit code groups passed up from the PMA into octets for use by the upper layers. The PCS also controls the auto-negotiation process which allows two separate gigabit devices to establish a link of which they are both capable of using.

The PMA is responsible for serializing each ten bit code group received from the PCS and sending the serialized data to the PMD. The PMA is responsible for deserializing every ten bit code group received from the PMD and passing it to the PCS. The PMA is also responsible for obtaining octet alignment by aligning the incoming serial data stream prior to passing ten bit code words up to the PCS. The synchronization process in the PCS provides frame alignment. As part of an Ethernet interface, a serdes (serial to parallel block) is located in the receive direction. In most implementations, a 1 G Ethernet interface operates at 1.25 gbps on the serial side and 125 MHz on the parallel side. This creates a 10 bit parallel interface (e.g., ENC_RXD[0:0], ENC_TXD[0:9]). The position of the beginning of the SFD can be anywhere in the 10 bit parallel interface. Once synchronization via the octet alignment process of the PMA is performed, the alignment of the octet boundary to the parallel bus boundary can be performed. Then the frame synchronization process of the PCS can occur which determines the SFD position within Ethernet frame. The position of the SFD (e.g., SFD_POS) can be determined within the 10 bit interface (e.g., by using distance of pointer to SFD from start of FIFO). When the PCS synchronization is lost, the SFD position can no longer be guaranteed.

After the octet synchronization of the PMA, a shifting of bits occurs (e.g., using a barrel shifter) so the SFD aligns with the 10 bit bus. This is the realignment process which moves the position of the bits, so the SFD aligns with the parallel bus boundary, and adds the delay variation. This delay variation changes each time a new resync occurs (each time the Ethernet cable is removed and reinserted for example). This variable delay is measured and compensated for by the delay measurement block 218. For example, with XGMII, the SFD boundary may occur on four octet boundaries, so the realignment process may cause greater delay variation. The measurement can be done in different ways. In various embodiments, the measurement is based on how far off the SFD position is from the 10-bit bus boundary. In some embodiments, the delay measurement block 218 implements a measurement scheme that checks the bus boundary against the octet alignment or SFD position (e.g., SFD_POS), and adjusts the timestamp accordingly. However, other ways that the measurement can be made are available in the industry.

For 10 G Ethernet, the bus is typically 64 bits wide. The input side operates at 10.3125 Gbps, while the parallel side operates at 161.13 Mbps (e.g., 10.3125/64). After the octet alignment by the PMA, the PCS synchronization block 210 detects the code that locates the position of the SFD and then a shift or repositioning of the alignment point to the bus boundary occurs. In various embodiments, the delay measuring process measures the offset between the octet alignment/sync alignment point and the bus boundary (e.g., as part of the functionality in the PCS/MAC block).

The delay measuring process optionally obtains the serdes delay variation (e.g., may be read from a software (SW) provisioned table). In one example, the delay variation of the serdes may be determined from a manufacture data sheet and implemented in a software (SW) or hardware (HW) lookup table (LUT). The delay measuring process takes the value in PCS delay value alone (less precise) or combines the two offsets (most precise) to obtain a much more precise timestamping value at the input to the Ethernet interface.

Because every time there is a resync (e.g., a cable removed and reinserted) the delay through the PCS changes. Higher precision timestamps are created by measuring the delay through the PCS block. The measurement of the serdes delays may also be determined, which creates even further precision. Measuring the delay through the PCS block can be done in different ways. In various embodiments, the depth of an elastic buffer (ES) in the receive or transmit data path is measured, which is indicative of the delay through the PCS block.

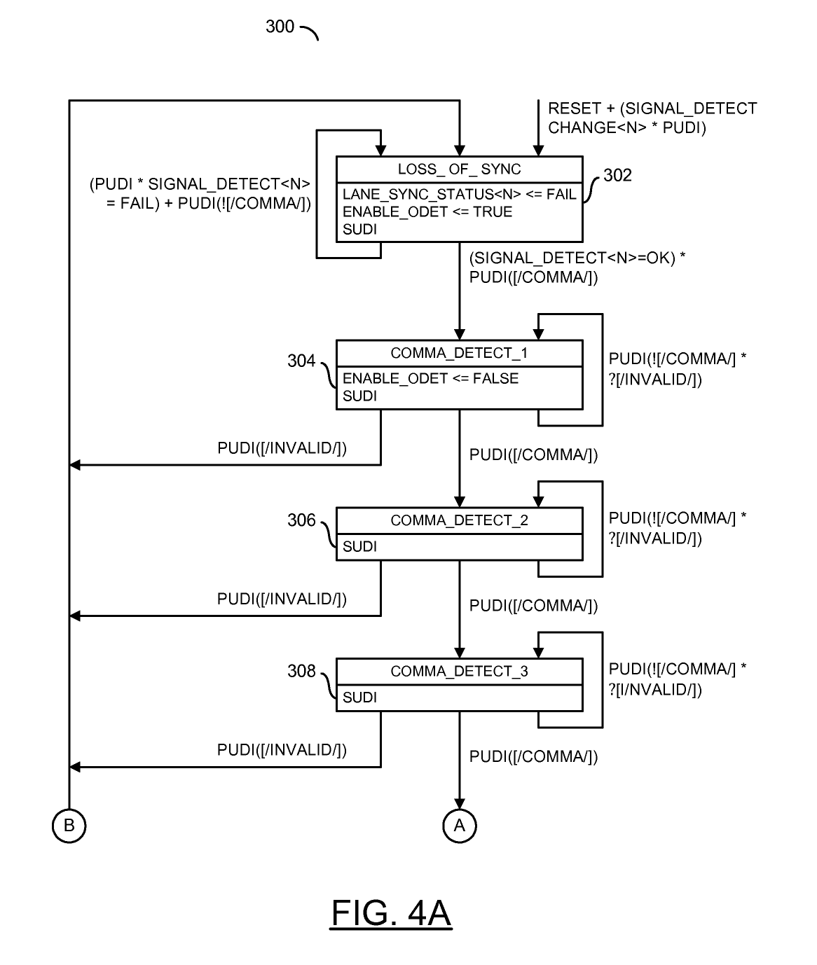

Referring to FIGS. 4(A-B), a state diagram of a process 300 is shown illustrating an example operation of the PCS synchronization block 210 of FIG. 3. In various embodiments, the PCS synchronization block 210 may implement a PCS synchronization process similar to one described in Section 36.2 of IEEE Std 802.3-2008, which is herein incorporated by reference. The PCS acquires synchronization based upon the octet aligned code groups being received by the underlying PMA. After powering on or resetting, the PCS synchronization block 210 does not have synchronization (e.g., the flag lane_sync_status is set to FAIL) and the process (or method) 300 is in a LOSS_OF_SYNC state 302. The process 300 looks for the reception of a code_group containing a comma (e.g. /COMMA/). In some embodiments, /COMMA/ is implemented as the set of 256 code_groups corresponding to valid data as specified in Section 36.2.4.9 and listed in Table 36-2 of IEEE Std 802.3-2008, which are herein incorporated by reference. The PMA block typically provides octet alignment of the code_groups. The process 300 then assigns that code_group to be an even-numbered code group. The next code_group received is assigned to be an odd-numbered code_group. Code_groups received thereafter are alternately assigned to even- and odd-numbered code_group alignments. Thus, synchronization is achieved upon the reception of three ordered_sets each starting with a code_group containing a comma. Each comma must be followed by an odd number of valid data code_groups. No invalid code_groups can be received during the reception of these three ordered_sets.

Synchronization is acquired if three consecutive ordered_sets which each begin with a /COMMA/ are received. The /COMMA/ must be followed by an odd number of valid data code_groups (e.g., /D/). In various embodiments, /D/ is implemented as the set of 256 code-groups corresponding to valid data as specified in section 36.2.4.11 of IEEE Std 802.3-2008, which is incorporated by reference. The number of /D/ code_groups following the /COMMA/does not have an upper limit. Each time an ordered_set which begins with a /COMMA/ is received, the PCS asserts a variable (e.g., CGGOOD) and the process 300 moves to the next step. If at any time prior to acquiring synchronization the PCS receives a /COMMA/ in an odd-numbered code_group or if the PCS receives an invalid code_group (e.g., /INVALID/), the process 300 asserts a variable (e.g., CGBAD) and returns to the LOSS_OF_SYNC state 302. In various embodiments, /INVALID/ is implemented as a code group that is not found in the correct running disparity column of Tables 36-1 or 36-2 of IEEE Std 802.3-2008, which are herein incorporated by reference. Once three consecutive ordered_sets which each begin with a /COMMA/ are received, the process 300 moves to the SYNC_ACQUIRED_{—}1 state 310 and sets the flag lane_sync_status=OK when synchronization is acquired. The following section defines how the PCS can lose synchronization once synchronization has been acquired.

### Maintaining and Losing Synchronization

While in the SYNC_ACQUIRED_{—}1 state 310, the process 300 examines each new code_group. If the code_group is a valid data code_group or contains a comma and is designated as an odd-numbered code_group (e.g., the flag rx_even is FALSE), the PCS asserts the variable CGGOOD and the process 300 toggles the flag rx_even. Otherwise, the PCS asserts the variable CGBAD and the process 300 moves to the SYNC_ACQUIRED_{—}2 state 312, toggles the flag rx_even, and sets a variable (e.g., GOOD_CGS) to 0. If the next code_group is a valid code_group which causes the PCS to assert the variable CGGOOD, the process 300 transitions to the SYNC_ACQUIRED_{—}2A state 314, toggles the flag rx_even, and increments the variable GOOD_CGS. Otherwise the process 300 continues on to the SYNC_ACQUIRED_{—}3 state 316.

While in the SYNC_ACQUIRED_{—}2A state 314, the process 300 examines each new code_group. For each code_group which causes the PCS to assert CGGOOD, the variable GOOD_CGS is incremented. If GOOD_CGS reaches three and if the next code_group received asserts CGGOOD, the process 300 returns to the SYNC_ACQUIRED_{—}1 state 310.

Otherwise, the process 300 transitions to the SYNC_ACQUIRED_{—}3 state 316. Once in the SYNC_ACQUIRED_{—}3 state 316, the process 300 may return to the SYNC_ACQUIRED_{—}2 state 312 via the SYNC_ACQUIRED_{—}3A state 314 using the same mechanisms that take the process 300 from the SYNC_ACQUIRED_{—}2 state 312 to the SYNC_ACQUIRED_{—}1 state 310. However, another /INVALID/ code_group or /COMMA/ received when the flag rx_even is TRUE will take the process 300 to the SYNC_ACQUIRED_{—}4 state 320. If the process 300 fails to return to the SYNC_ACQUIRED_{—}3 state 316 via the SYNC_ACQUIRED_{—}4A state 322, the process 300 transitions to the LOSS_OF_SYNC state 302, where lane_sync_status is set to FAIL. In various embodiments, the values, variables, functions, etc. shown in FIGS. 4A and 4B may be implemented similarly to those described in sub-sections of Section 36.2.5 of IEEE Std 802.3-2008, which is herein incorporated by reference.

Referring to FIG. 5, a diagram of an Ethernet frame 50 is shown illustrating a start-of-frame delimiter (SFD) 52. Many wireless cellular communication networks are deployed using Ethernet networks. Therefore, Ethernet packets are used to carry timing information between nodes of the networks. Timestamp generation generally involves detecting the Ethernet start-of-frame delimiter (SFD) 52 and using the SFD 52 as a trigger for generating a timestamp value. The SFD 52 is at a common point for all Ethernet frames (e.g., the eighth byte of the frame). In timestamping systems, the goal is to create as little delay variation or unknown fixed delays between the incoming Ethernet port and detection of the SFD 52. The more precise the detection of the SFD 52 is, the more precise the overall timestamp accuracy will be.

Referring to FIG. 6, a diagram is shown illustrating relevant portions of an Ethernet reference model 60. The hierarchy of the reference model is divided into a number of layers. The layers include physical (PHY) layer 61, data link layer 63, network layer 65, transport layer 67, session layer 69, presentation layer 71, and application layer 73. The data link layer includes a media access control (MAC) client 62 and a MAC sublayer 64. In some embodiments the MAC client 62 includes a logical link control (LLC) sublayer. The PHY layer 61 includes a reconciliation sublayer (RS) 66, a media independent interface (MII) 68, a physical coding sublayer (PCS) 70, a physical medium attachment (PMA) sublayer 72, an auto-negotiation sublayer 74, a physical medium dependent (PMD) sublayer including a medium dependent interface (MDI) 76, and any communication medium (e.g., copper, optical fiber, RF, etc.). The RS sublayer processes PHY local/remote fault messages and handles DDR (double data rate) conversion. The PCS sublayer performs autonegotiation and coding such as 8 b/10 b encoding. The PMA sublayer performs PMA framing, octet synchronization/detection, and scrambling/descrambling. The PMD sublayer performs a transceiver function for the physical medium. The Ethernet physical coding sublayer (PCS) is part of the Ethernet physical (PHY) layer. The RS 66 and MII 68 are collectively referred to as media independent sublayers. The PCS 70, PMA 72, auto-negotiation 74, MDI 76, and medium 78 are collectively referred to as media dependent sublayers.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
a synchronization block configured to determine a position of a start of frame delimiter; and
a physical coding sublayer block configured to measure a delay through the physical coding sublayer block and provide delay and delay variation compensation based upon the measured delay.

2. The apparatus according to claim 1, wherein said physical coding sublayer block is configured to measure said delay by measuring an offset of said start of frame delimiter from a bus boundary.

3. The apparatus according to claim 1, further comprising a timestamp counter, wherein a timestamp value is adjusted based upon said delay and delay variation compensation.

4. The apparatus according to claim 1, further comprising a serializer/deserializer block, wherein said delay and delay variation compensation is further based upon a delay variation associated with said serializer/deserializer block.

5. The apparatus according to claim 4, wherein said delay variation associated with said serializer/deserializer block is obtained from a lookup table.

6. The apparatus according to claim 5, wherein said lookup table is generated using software executed by said apparatus.

7. The apparatus according to claim 6, wherein said lookup table is generated based on characteristics of said serializer/deserializer block.

8. The apparatus according to claim 1, wherein said apparatus is configured to provide Time of Day (ToD) synchronization for a wireless network.

9. The apparatus according to claim 1, wherein said physical coding sublayer block and said synchronization block are part of an Ethernet transceiver.

10. The apparatus according to claim 9, wherein said Ethernet transceiver is part of a wireless communication network.

11. The apparatus according to claim 1, wherein said delay and delay variation compensation compensates for a delay in detection of said start of frame delimiter.

12. The apparatus according to claim 1, wherein said delay and delay variation compensation compensates for a delay in detection of a phase between an Ethernet start-of-frame delimiter and a bus boundary.

13. The apparatus according to claim 1, wherein said delay and delay variation compensation compensates for delay variation due to loss and reacquisition of synchronization.

14. The apparatus according to claim 1, wherein measuring said delay through the physical coding sublayer block comprises measuring a depth of an elastic buffer.

15. A method of compensating for delay and delay variation in a physical coding sublayer of an Ethernet interface comprising the steps of:
determining a position of a start of frame delimiter;
measuring a delay through the physical coding sublayer; and
providing delay and delay variation compensation based upon the measured delay.

16. The method according to claim 15, wherein said delay is measured from a physical media attachment interface to a media independent interface of said physical coding sublayer.

17. The method according to claim 15, wherein measuring said delay through the physical coding sublayer comprises measuring a depth of an elastic buffer.

18. The method according to claim 15, wherein providing delay and delay variation compensation based upon the measured delay comprises:
adjusting a timestamping value of said Ethernet interface based upon the measured delay through the physical coding sublayer.

19. The method according to claim 15, further comprising:
obtaining a measurement of a delay variation of a serializer deserializer block of said Ethernet interface;
combining the measured delay through the physical coding sublayer and the measurement of the delay variation of the serializer deserializer block; and
adjusting a timestamping value of said Ethernet interface.
